(19) United States
(12) Patent Application Publication
(10) Pub. No.: US 2023/0155333 A1
(43) Pub. Date: May 18, 2023

(54) Electrical Power Connector for Contacting an Elongated DC Power Distribution Busbar, and Method of Monitoring a Connection

(71) Applicant: TE Connectivity Germany GmbH, Bensheim (DE)

(72) Inventors: Frank Keutz, Bensheim (DE); Ingo Rothenberger, Dortmund (DE)

(73) Assignee: TE Connectivity Germany GmbH, Bensheim (DE)

(21) Appl. No.: 17/989,890

(22) Filed: Nov. 18, 2022

(30) Foreign Application Priority Data
Nov. 18, 2021 (WO) 21209013.8

(51) Int. Cl. H01R 25/14; H01R 13/11; H01R 13/66; H01R 13/15

(52) U.S. Cl. CPC H01R 25/14; H01R 13/11; H01R 13/6683; H01R 13/15

(57) ABSTRACT

An electrical power connector includes a connector housing having a receptacle receiving an elongated DC power distribution busbar, a first spring contact element arranged at a first side of the receptacle and pressed with a contact area to a first surface of the elongated DC power distribution busbar, and a second spring contact element pressed to a second surface of the elongated DC power distribution busbar opposite the first surface. The second spring contact element is arranged at a second side of the receptacle opposite to the first side. The power connector includes a temperature sensing device arranged inside the connector housing and monitoring a temperature at the first spring contact element and/or the second spring contact element.

### CROSS-REFERENCE TO RELATED APPLICATION

This application claims the benefit of the filing date under 35 U.S.C. § 119(a)-(d) of European Patent Application No. 21209013.8, filed on Nov. 18, 2021.

### FIELD OF THE INVENTION

The present disclosure relates to an electrical power connector for contacting an elongated DC power distribution busbar and to a method of monitoring such a connection.

### BACKGROUND

This disclosure generally relates to systems for distributing electrical power from a junction box to electrical devices via a busway or track, to which distribution sub-assemblies or power taps may be removably connected without shutting down the power supply. The busway or track includes multiple conductors, the busbars, to provide DC power.

Further, the Open Compute Project Foundation (OCP) was initiated in 2011 with a mission to apply the benefits of open source and open collaboration to hardware and rapidly increase the pace of innovation in, near and around data centers. As part of the OCP, DC power connectors are needed which are connecting to a busbar of a data center rack cabinet as part of a power supply. This connector has two poles, i.e. plus and minus, and is transmitting a current of e. g. 500 Ampere. For contacting an elongated flat busbar where the opposing surfaces are insulated against each other and can be connected to these opposing poles, the connector is a modified edge connector with spring contacts being pressed onto the busbar contact surface. The connectors are in particular used for power shelves, battery backup unit (BBU) shelves, IT trays/cubby shelves, or server sleds.

Because of the high current, the connector materials heat up. This temperature rise should normally stay within the required limits of the admissible maximum temperature of the respective application.

The proper function of the connector highly relies on the proper function of spring beams and that each of the multiple spring beams carry an even load. Vice versa, if one spring beam should have a malfunction, then the remaining spring beams will have to carry additional current load and therefore will heat up more. More heat will result in the risk that the spring properties of the remaining springs will soften and could cause higher contact resistance. This results again in more heat dissipation and could end up as a chain reaction with the result that the cabinet can catch fire.

### SUMMARY

An electrical power connector includes a connector housing having a receptacle receiving an elongated DC power distribution busbar, a first spring contact element arranged at a first side of the receptacle and pressed with a contact area to a first surface of the elongated DC power distribution busbar, and a second spring contact element pressed to a second surface of the elongated DC power distribution busbar opposite the first surface. The second spring contact element is arranged at a second side of the receptacle opposite to the first side. The power connector includes a temperature sensing device arranged inside the connector housing and monitoring a temperature at the first spring contact element and/or the second spring contact element.

### BRIEF DESCRIPTION OF THE DRAWINGS

The invention may be understood by reference to the following description taken in conjunction with the accompanying figures, in which reference numerals identify features of the invention.

FIG. 1 is a perspective view of a power supply shelf for a data center;

FIG. 2 is a perspective view of the power supply shelf connected to a DC power busbar;

FIG. 3 is a perspective view of a cable harness with a power connector;

FIG. 4 is a perspective view of the power connector;

FIG. 5 is another perspective view of the power connector;

FIG. 6 is a perspective view of a spring contact element;

FIG. 7 is a perspective view of the power connector of FIG. 4 without a housing;

FIG. 8 is a detail perspective view of the power connector of FIG. 4 without the housing;

FIG. 9 is a schematic diagram of a temperature sensor;

FIG. 10 is a sectional perspective view of the power connector of FIG. 4;

FIG. 11 is a sectional perspective view of an MID mounted temperature sensor;

FIG. 12 is a sectional perspective view of a temperature sensing device according to another embodiment with a housing; and

FIG. 13 is a detail perspective view of the temperature sensing device of FIG. 12.

### DETAILED DESCRIPTION OF THE EMBODIMENT(S)

The accompanying drawings are incorporated into the specification and form a part of the specification to illustrate several embodiments of the present disclosure. These drawings, together with the description, serve to explain the principles of the disclosure. The drawings are merely for the purpose of illustrating examples of how the disclosure can be made and used, and are not to be construed as limiting the disclosure to only the illustrated and described embodiments. Furthermore, several aspects of the embodiments may form—individually or in different combinations—solutions according to the present disclosure. The following described embodiments thus can be considered either alone or in an arbitrary combination thereof. Further features and advantages will become apparent from the following more particular description of the various embodiments of the disclosure, as illustrated in the accompanying drawings, in which like references refer to like elements.

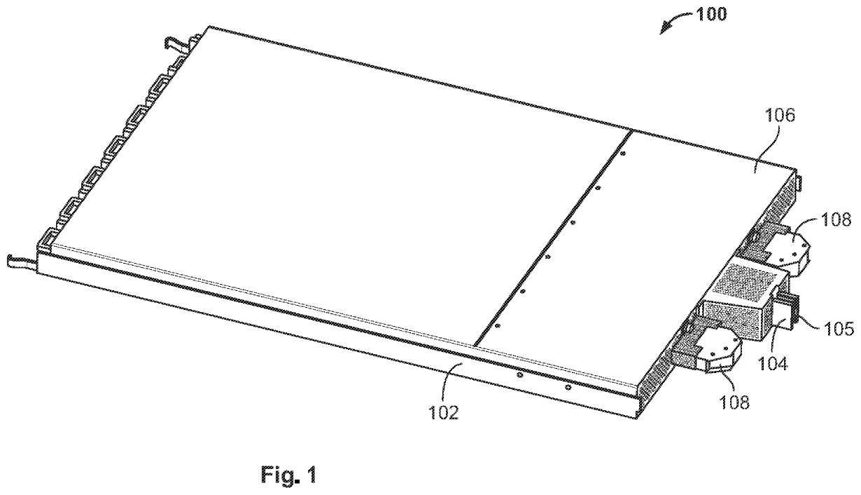

The present disclosure will now be further explained referring to the Figures, and firstly referring to FIG. 1. FIG. 1 shows a perspective view of an exemplary power supply shelf 100 for a data center. The power supply shelf 100 may for instance be compatible to the open compute project (OCP). The power supply shelf 100 comprises a metal casing 102 with a cover 106 protecting the electronic components mounted on the power supply shelf 100. The electronic components may, for instance, comprise AC/DC converters for providing a DC power from an AC source. The AC input power is connected to the power supply shelf 100 via input connectors 108. The DC power is output via an electrical power connector 104 for contacting an elongated DC power distribution busbar.

Various electronic components, e. g. AC/DC converters, are connected to the input connectors 108 via input cables. Furthermore, a plurality of output cables 114 connected to the electronic components are attached to the power connector 104. The power connector 104 has a receptacle 105 which in a mounted state partly encompasses the DC power distribution busbar to contact it in the manner of an edge connector.

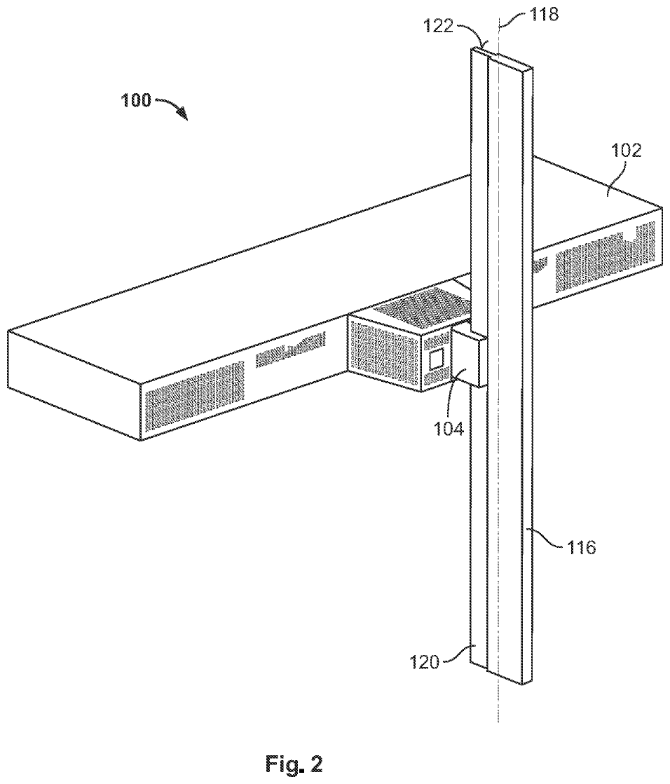

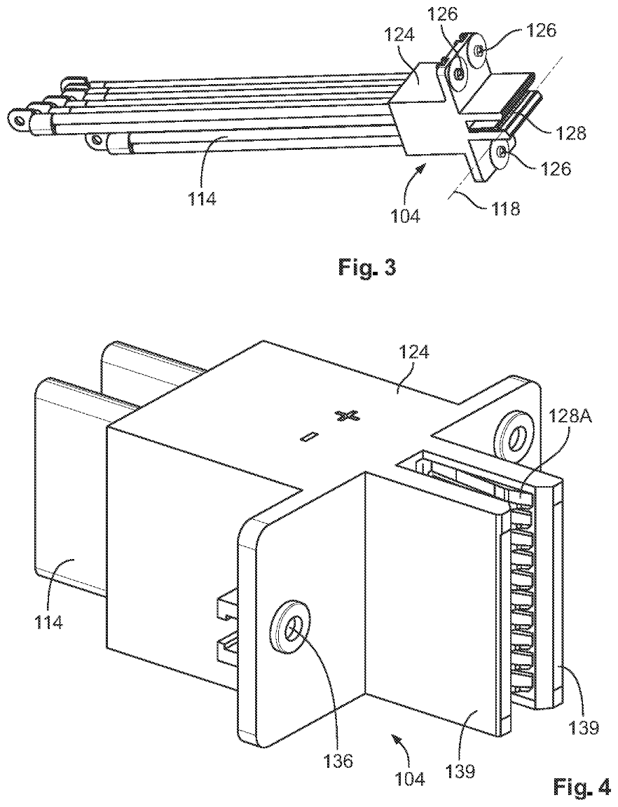

FIG. 2 illustrates schematically the connection between the power supply shelf 100 and a DC power distribution busbar 116. It should be noted that for reasons of simplifying the drawing, the input connectors 108 are not shown in FIG. 3. The elongated DC power distribution busbar 116 and the connector 104 have a common longitudinal axis 118. The busbar 116 has a first electrically conductive surface 120 and a second electrically conductive surface 122. The first electrically conductive surface 120 and the second electrically conductive surface 122 are arranged on opposing sides of the busbar 116. Thus, the first electrically conductive surface 120 and the second electrically conductive surface 122 can be connected to a positive and a negative pole of the DC power, respectively.

The connector 104 grips the busbar 116 similar to a card edge connector. As will become more apparent from the following Figures, the connector 104 according to one example has spring contacts arranged opposite to each other so that the first electrically conductive surface 120 and the second electrically conductive surface 122 are electrically contacted by the electrical power connector 104.

FIG. 3 schematically depicts an example of an electrical power connector 104 with a set of cables 114 attached thereto. However, it is clear that the electrical power connector 104 may also be designed to be connected to a flexible foil or to the conductive leads of a printed circuit board (PCB) for being connected the electronic components of the power supply shelf.

The electrical power connector 104 has an electrically insulating housing 124, shown in FIGS. 3 and 4, which is for instance fabricated from a plastic material. Screw connectors 126 fix the electrical power connector 104 at the casing 102 of the power supply shelf 100. As will become more apparent from the following Figures, the electrical power connector 104 comprises two rows of spring contact elements 128, each row of spring contact elements 128 being configured to electrically contact one pole of the busbar 116.

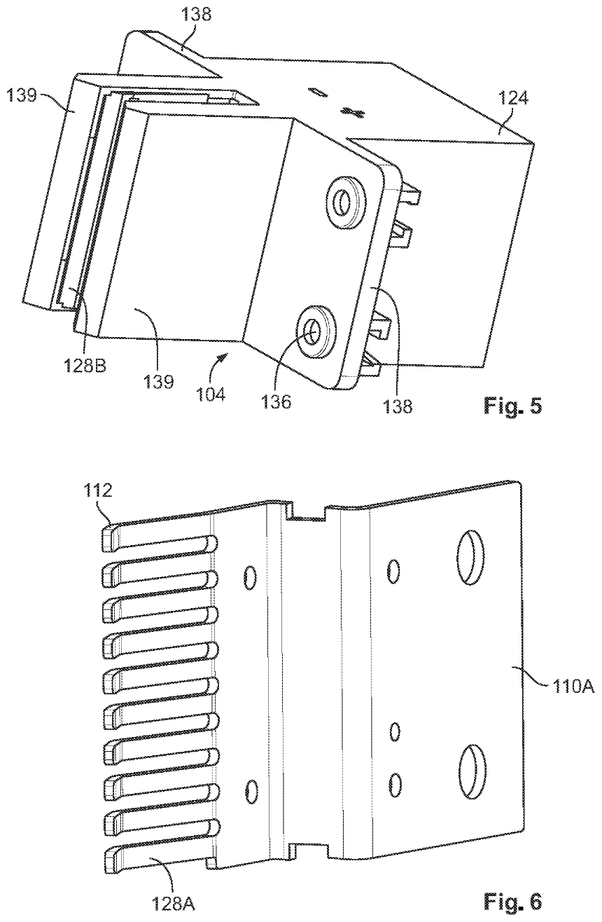

Turning now to FIGS. 4 and 5, these Figures show the electrical power connector 104 in more detail. The electrical power connector 104 comprises a row of equidistantly arranged first spring contact elements 128A and, opposite to the first spring contact elements 128A, a symmetrical row of equidistantly arranged second spring contact elements 128B. This construction allows for an evenly distributed contact force applied to the busbar and thus an evenly distributed current density. These spring contact elements are protected by a spring contact housing 139. The spring contact housings 139 are integrally formed with the remaining connector housing 124. Openings 136 are arranged at lateral mounting flanges 138 so that the connector 104 can be screwed to the power supply shelf 100.

When attached to the busbar 116 of FIG. 2, the first spring contact elements 128A contact the side of the busbar which represents the plus pole, while the second spring contact elements 128B contact the opposing side of the busbar which represents the minus pole.

FIG. 6 shows the plurality of spring contact elements 128A which are for instance integrally formed with a contact plate 110A. The contact plate 110A and the spring contact elements 128B are, in an embodiment, formed as a stamped and bent metal part. The contact plate 110A is connected to the output cables of one polarity (e. g. the positive polarity as shown in FIG. 5. Although not shown in the drawings, the opposing spring contact elements 128B of the electrical power connector 104 are formed mirror-symmetrically and are integrally fabricated with a contact plate to be connected to the output cables of the opposing polarity (here the negative polarity).

The spring contact elements 128 are each formed as resilient, unilaterally cut free spring arms with a contact region 112 for contacting the busbar 116 at the free end. The contact plate 110 with the spring contact elements 128 may, for instance, be fabricated from copper or steel. This construction allows a particularly easy connecting and disconnecting to/from the busbar 116 and is safe in that the spring forces are monitored via the temperature sensing devices 130. The opposing end of the spring arm has a connecting region at its fixed end which is connectable to a component to be provided with DC power. This may for instance be a crimp connection, a solder connection, a press-fit connection, a welded connection, or a plug connection. Any suitable form of a stable electrical connection can be used for contacting the spring contact elements 128 at their contact region 112.

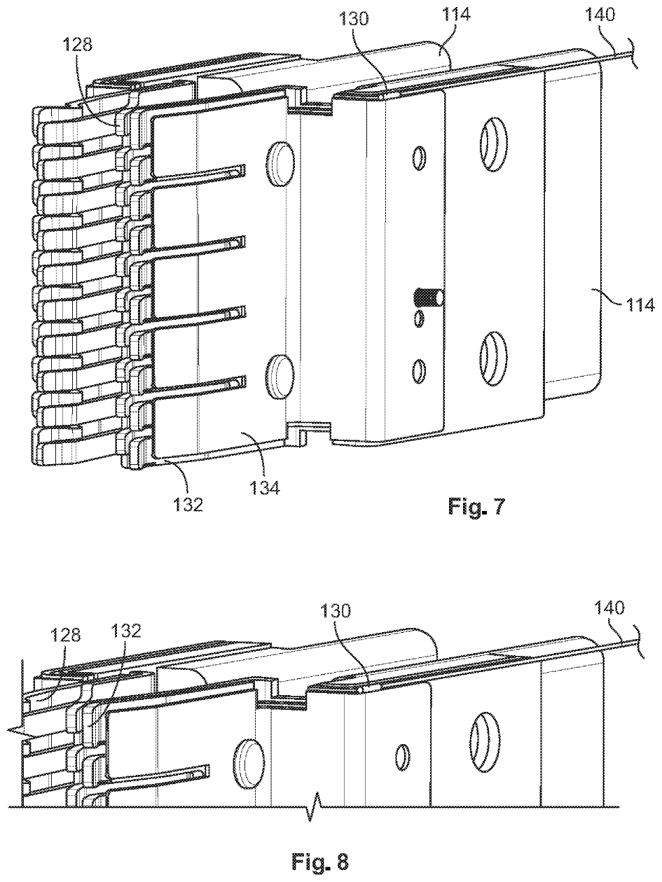

Furthermore, as illustrated in FIG. 7, where the housing 124 is not shown, the connector 104 comprises secondary springs 132 and a retaining bracket 134 for pressing the spring contact elements 128 towards the busbar 116.

It could be shown that it is essential for a failure free and safe operation that the spring forces of the first and second spring contact elements 128A, 128B are constant and remain essentially identical for all the spring contact elements 128. The same is valid for the spring characteristics of the secondary springs 132 and the retaining bracket 134. If the spring characteristics deteriorate due to a temperature rise, the spring forces lessen and the electrical resistance at the contact between the spring contact element 128 and the busbar surface increases. This increase in electrical resistance damages the spring contact element even more and a compounding effect resulting in the connector housing catching fire may occur. By attaching a temperature sensing device close to the secondary spring element 132, an overheating of this component as well as a decline of the spring force can be detected at an early stage.

In order to be aware of any rise in temperature which gives an early indication of an impending failure, the present disclosure proposes to arrange a temperature sensing device inside the connector housing 124. As can be seen from FIG. 7, for instance a temperature sensor, e. g. a thermocouple, 130 may be arranged in close vicinity with at least one of the rows of first and second spring contact elements 128A, 128B. Importantly, the temperature sensor 130 registers a rise in temperature at a very early stage of a deterioration of the electrical contact. The temperature sensor 130 may be in close vicinity, for example directly opposite, to a contact area in which the first spring contact element 128A contacts the first surface 120 of busbar 116.

The output signal of the thermocouple 130 can be used to generate a warning signal long before the danger of a compounding reaction arises. Providing the temperature sensing device 130 inside the housing 124 and as close as possible to the spring contacts 128A, 128B allows to detect a beginning failure condition before an irreversibly critical situation has been reached. In other words, a potential loss of the material characteristics of the spring contact can be detected in an early stage.

Temperature sensors essentially comprise an outer protective housing that is in contact with a medium to be monitored, and a temperature sensitive element which is arranged inside the protective housing and transduces the sensed temperature into the electrical output signal. In order to achieve fast response time and an accurate measurement, it is essential that a particularly good thermally conductive connection is provided between the temperature sensitive element and the outside medium, so that the temperature at the site of the temperature sensitive element mirrors the temperature outside the protective housing as exactly as possible. Any suitable type of temperature sensing element can be used in a temperature sensing device 130. For instance, said temperature sensing element comprises a resistive temperature detector (RTD), a thermistor, or a silicon-based temperature sensor.

In particular, silicon IC sensors which use single-crystal silicon permit on-chip fabrication of IC (integrated circuit) enhancements. However, the use of IC processes also restricts the operation of silicon-based temperature sensors to an upper limit of about 150° C. Two types of silicon sensors are in general use: spreading resistance based on bulk charge conduction and pn-junction voltage difference. Further, thermistors are based on ceramic-oxide compositions are manufactured to exhibit NTC or PTC (negative, or positive, temperature coefficient) resistance characteristics, where resistance of the sensors decrease, or increase, several orders of magnitude as temperature is increased. NTC sensors offer many advantages for temperature measurement, e.g. small size, durable stability, high accuracy, and precision. In so-called RTD (Resistive Temperature Detector) high-temperature sensors, a platinum-film sensing element is printed and then embedded inside an alumina-ceramic layered structure. The resistance of the platinum element linearly increases as temperature is increased.

A thermoelement sensor consists of two unequal metals, joined to each other at one end. The temperature is measured at this branching. The two metals generate a small voltage, which can be measured and evaluated by a control system. The unequal metals are insulated individually, and with the help of a jacket a tight bifilar configuration is maintained. Thermoelement sensors have the advantage of a wide operating temperature range, largely constant sensitivity over their entire range, and availability in suitable miniaturized sizes.

FIG. 8 illustrates a detail of FIG. 7. It should be noted that, in this Figure, the harness of output cables 114 is only represented in a simplified schematic manner. As shown in FIG. 8, the thermocouple 130 may have a two-pole wiring 140 which can be connected to a control unit arranged inside the power supply shelf. The control unit may evaluate the output signal of the temperature sensor 130 and compare it to a pre-defined threshold value of a maximum admissible temperature. Additionally or alternatively, also a time dependent temperature profile can be monitored in order to anticipate a potential risk of spring force degradation. In FIG. 8 a thermocouple 130 is shown which exemplarily may be used as a temperature sensing device according to the present disclosure.

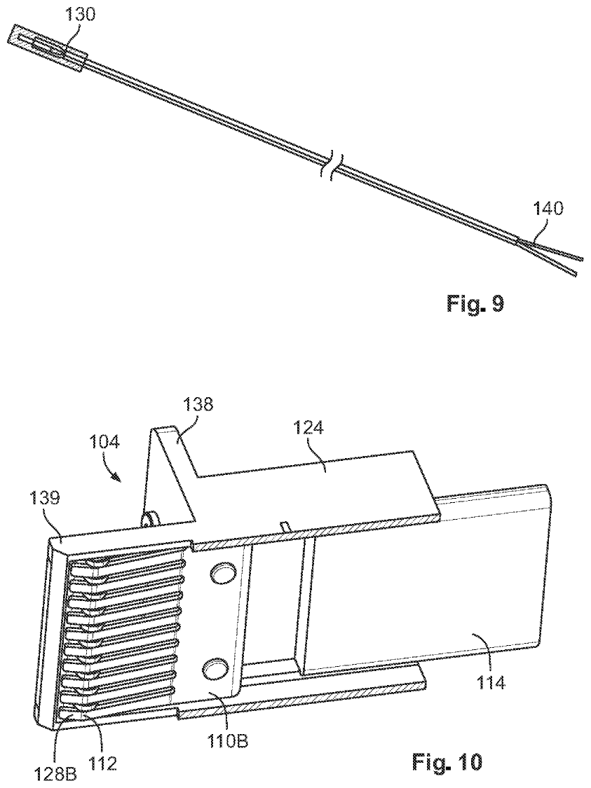

As an alternative, also a thermistor may be used as the temperature sensor. FIG. 9 exemplarily illustrates a micro thermistor probe 130. Such micro thermistor probes are advantageous in that they provide a rapid temperature response and can be mounted where space is limited. These miniature thermistors are potted in a polyimide tube with a thermally conductive epoxy. The sensing element comprises an NTC sensor, i. e. a sensor with negative temperature coefficient resistance characteristics, where resistance of the sensor decreases several orders of magnitude as temperature increases.

Of course, any other suitable temperature sensing means may also be used as the temperature sensor 130. The temperature sensing device 130, in various embodiments, may comprise at least one temperature sensing element formed by a positive temperature coefficient, PTC, thermistor, and/or a negative temperature coefficient, NTC, thermistor, and/or a non-linear thermal resistor, and/or a pyroelectric sensor, and/or a bimetallic sensor.

In order to monitor a plurality of spring contact elements more closely and thus enhance the operational safety of the power connector, the temperature sensing device 130 may comprise two or more temperature sensing elements. In an embodiment, these temperature sensing elements are arranged distanced apart along a longitudinal axis which in operation extends along the longitudinal axis of the busbar 116.

In order to provide a smart connector comprising some degree of intelligence, the temperature sensing device 130 is formed as an integrated component comprising an analog-digital-converter for generating a digital output signal.

As an alternative to using a transducer element that outputs a signal indicative of a temperature, the temperature sensing device 130 may comprise a current sensing unit for monitoring a current value at the at least one first and/or second spring contact element 128A, 128B and an evaluation unit which is operable to calculate the temperature from the sensed current value.

As the main current flows generate magnetic fields, it is possible to place one or more coil like sensors at the contact areas to measure the power of the magnetic fields, if a field gets weaker in a certain area it would indicate that current goes down because of higher contact resistance—this indicates a energy loss by heat dissipation. Of course, any other magnetic field sensor may also be used, e. g. a Hall-effect sensor.

According to a further advantageous example, the temperature sensing device 130 comprises a separately housed sensor unit which is arranged to be in direct mechanical contact with the at least one first and/or second spring contact element 128A, 128B. This allows the use of prefabricated components and even a retrofitting of existing connectors. An advantage of using such separately housed components can be seen in the fact that already existing connectors 104 may be retrofitted with a temperature sensing device.

However, also an integrated solution based on an MID component may advantageously be used. As mentioned above, MID is the abbreviation of the term “molded interconnect device” and comprises a three-dimensional circuit carrier which is injection molded from a modified polymeric material. This modification may allow laser activation of circuit tracks on the surface of the circuit carrier. The activated areas become metallized in a chemical metallization bath in order to build conductive tracks which are thus extending into the third dimension. Apart from laser direct structuring (LDS) techniques (additive as well as subtractive) also a two-shot injection molding, hot embossing, and insert molding can be used for fabricating a three dimensional substrate that may be employed for assembling a temperature sensing unit according to the present disclosure. Advantageously, the connector housing may at least partly be formed as a molded interconnect device, having a plurality of conductive leads, wherein the temperature sensing means is mounted at the connector housing and is connected to the conductive leads.

If an LDS printed conductor path or any other 2D or 3D conductor printing process according to MID and/or LDS technology is applied to one of the inner half of the insulation body of the connector housing, then a digital sensor temperature sensor can be applied directly in the area of the contact springs and no wiring will be needed to connect a sensor in that area. Applying such sensor gives additional benefits as the digital sensor can be also packed as a system-on-chip (SOC) with an integrated microcontroller. Therefore, the sensor advantageously may be programmed to give a signal output which indicates an error. Such a smart connector may be operable to perform self-diagnosis and may also be part of a decentralized monitoring and safety system.

The present invention results in the higher integration of temperature diagnostics for a busbar/card edge style connector by placing temperature sensing devices 130 directly at the contact spring, using conventional wired sensor components or MID/LDS technologies for the wiring. Of course, also a wireless communication interface can be provided for outputting the error signal.

FIG. 10 shows a sectional view of the electrical power connector 104. According to a further advantageous example of the present disclosure, the temperature sensing device may also be integrated into the housing material, e. g. directly into at least one of the spring contact housings 139.

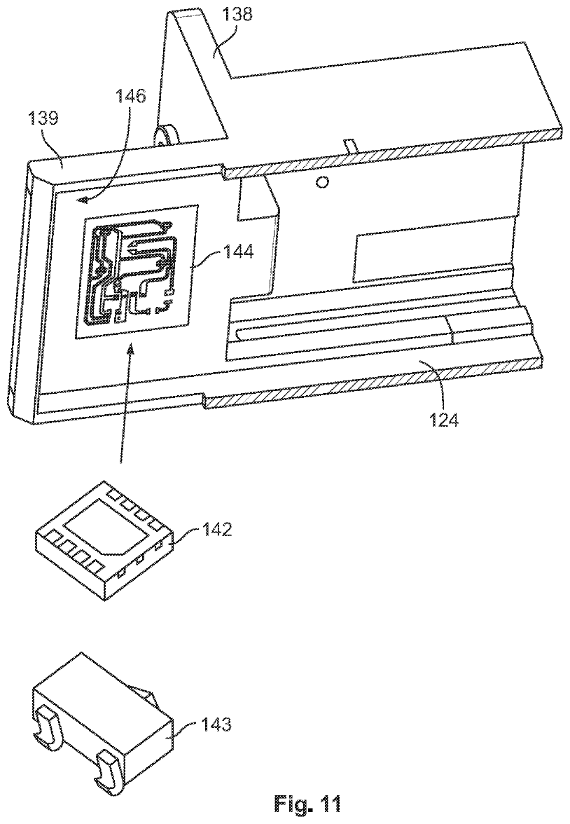

A first example is shown in FIG. 11, where the spring contact elements 128 and the output cable 114 are removed to show the inner surface 146 of the connector housing 124. As schematically illustrated, a lead pattern 144 is arranged on the inner surface of the connector housing 124. A, for example, digital temperature sensor 142, an integrated component, may be soldered to the electrically conductive lead pattern 144. The digital temperature sensor 142 is exemplarily depicted as a surface mount device (SMD) digital sensor. Alternatively, a discrete voltage temperature sensor 143 may also be used.

The advantage of this arrangement can be seen in providing a connector where the temperature detection as well as a basic signal evaluation can be performed directly at the site to be monitored. The safety and robustness of the electrical power connector can thus be enhanced.

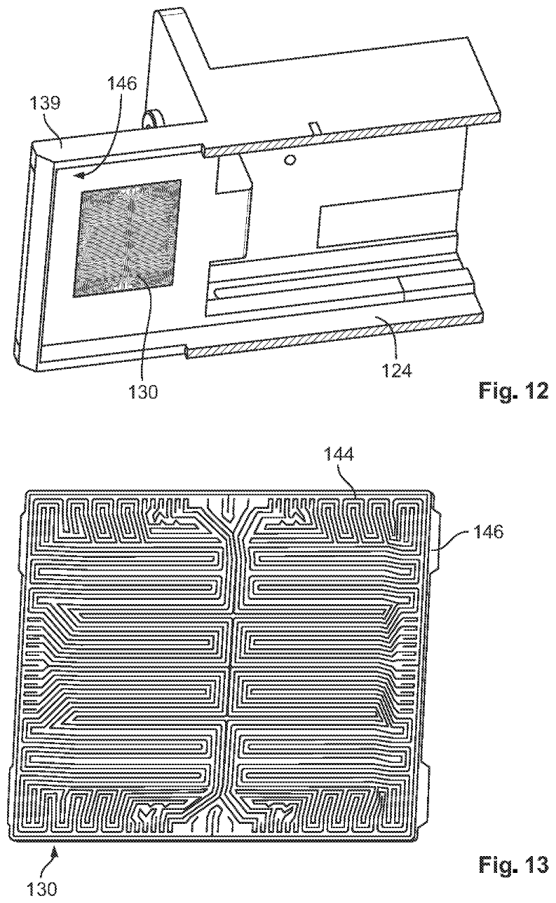

According to a further example of the present disclosure, the inner surface 146 of the connector housing 124 may directly provide the substrate for a temperature sensor. For instance, as schematically shown in FIGS. 12 and 13, lead patterns 144 forming one or more temperature sensors may be deposited directly onto the inner surface 146 of the spring contact housing 139.

FIG. 13 shows an example of such a temperature sensor 130 formed by a pattern 144 of resistive leads on the inner surface 146 of the spring contact housing 139. The resistive leads may for instance form a platinum resistance sensor. Alternatively, coil style sensors which measure the magnetic field strength may be used for indirectly measuring the temperature.

This extremely high level of integration allows for a minimal space requirement, a reduced component complexity and enhanced fabrication efficiency, and at the same time provides high accuracy and operational safety of the temperature monitoring process.

A method according to an embodiment of monitoring a connection between at least one electronic component to a DC power distribution busbar 116, using such an electrical power connector 104, comprises the following steps:

connecting the electrical power connector 104 to the elongated DC power distribution busbar 116, so that the at least one first spring contact element 128A contacts a first pole 120 of said DC power distribution busbar and the at least one second spring contact element 128B contacts a second pole 122 of said DC power distribution busbar,

connecting the temperature sensing device 130 to a control unit which reads an output signal of the temperature sensing device 130 and generates a warning signal if the output signal is indicative of an abnormal operational state.

Such a warning (or alarm) signal allows the system to react to the abnormal state in an early state, so that no catastrophic event such as a fire results. For instance, the output signal of the temperature sensing device 130 may be compared to a predefined temperature threshold value, and the warning signal is generated if the output signal exceeds the threshold value. In order to create an early warning system, this threshold can be chosen to be much lower than the actual admissible maximum temperature of the connector components.

As mentioned above, an alternative method of determining the temperature at the spring contact elements 128 involves determining the current density at the at least one first and/or second spring contact element 128A, 128B and calculating the respective temperature therefrom. Such a temperature measurement without a dedicated sensor by monitoring e. g. the current through the device and using of connector specific algorithms to calculate the critical thermal energy reduces the required space and enhances the accuracy of the monitoring.

Coil style sensors which measure the magnetic field strength are used for indirectly measuring the temperature. Of course, any other magnetic field sensor may also be used, e. g. a Hall-effect sensor.

Furthermore, advantageously the control unit is arranged inside the electrical power connector, and the warning signal is a shutdown signal which disconnects the at least one electronic component from the DC power distribution busbar. Thus, a particularly fast reaction to a potential failure and fire hazard can be achieved.

The present disclosure adds a temperature sensing device, such as the thermistor 130, in the area of the spring contact elements 128. Customers can, for instance, implement the data provided from the thermistor 130 into a permanent diagnostics routine which can be linked to an alarm system. In case of failure, the alarm system which could for example switch off the 500 A load from the connector and by doing this may avoid fire hazard. For an even more precise thermal diagnostic there may be also applied two or more thermistors 130, so that default parameter changes (like an increase of the ambient temperature) could be excluded from the control diagnostics. Thus, an individual thermistor showing alarming parameters can be identified. In other words, a predictive maintenance of the connector can be achieved, enhancing the safety of the connector in operation.

What is claimed is:

1. An electrical power connector, comprising:
a connector housing having a receptacle receiving an elongated DC power distribution busbar;
a first spring contact element arranged at a first side of the receptacle and pressed with a contact area to a first surface of the elongated DC power distribution busbar;
a second spring contact element pressed to a second surface of the elongated DC power distribution busbar opposite the first surface, the second spring contact element is arranged at a second side of the receptacle opposite to the first side; and
a temperature sensing device arranged inside the connector housing and monitoring a temperature at the first spring contact element and/or the second spring contact element.

2. The electrical power connector of claim 1, further comprising a secondary spring element in force transmitting contact with the first spring contact element and/or the second spring contact element.

3. The electrical power connector of claim 1, wherein the temperature sensing device has a temperature sensing element formed by at least one of: a positive temperature coefficient thermistor, a negative temperature coefficient thermistor, a non-linear thermal resistor, a pyroelectric sensor, and a bimetallic sensor.

4. The electrical power connector of claim 3, wherein the temperature sensing devices is an integrated component having an analog-digital-converter for generating a digital output signal.

5. The electrical power connector of claim 1, wherein the temperature sensing device has a current sensing unit monitoring a current value at the first spring contact element and/or the second spring contact element.

6. The electrical power connector of claim 5, wherein the temperature sensing device has an evaluation unit operable to calculate a temperature from the current value.

7. The electrical power connector of claim 1, wherein the temperature sensing device includes a separately housed sensor unit arranged in direct mechanical contact with the first spring contact element and/or the second spring contact element.

8. The electrical power connector of claim 1, wherein the connector housing is at least partly formed as a molded interconnect device having a plurality of conductive leads.

9. The electrical power connector of claim 8, wherein the temperature sensing device is mounted at the connector housing and is connected to the conductive leads.

10. The electrical power connector of claim 8, wherein the temperature sensing device is a printed sensing element arranged on the connector housing.

11. The electrical power connector of claim 1, wherein the first spring contact element and/or the second spring contact element is a unilaterally cut free spring arm with a contact region contacting the elongated DC power distribution busbar.

12. The electrical power connector of claim 11, wherein the spring arm has a connecting region at a fixed end that is connectable to a component provided with DC power and/or a component operable to output DC power.

13. The electrical power connector of claim 1, wherein the first spring contact element is one of a plurality of first spring contact elements arranged equidistantly along a longitudinal axis and the second spring contact element is one of a plurality of second spring contact elements arranged equidistantly along the longitudinal axis.

14. The electrical power connector of claim 1, wherein the temperature sensing device includes a plurality of temperature sensing elements.

15. A method of monitoring a connection between an electrical component and an elongated DC power distribution busbar using an electrical power connector, comprising:
connecting the electrical power connector to the elongated DC power distribution busbar with a first spring contact element of the electrical power connector contacting a first pole of the elongated DC power distribution busbar and a second spring contact element of the electrical power connector contacting a second pole of the elongated DC power distribution busbar;
connecting a temperature sensing device to a control unit that reads an output signal of the temperature sensing device; and
generating a warning signal if the output signal indicates an abnormal operational state.

16. The method of claim 15, wherein the output signal is compared to a predefined temperature threshold value and the warning signal is generated if the output signal exceeds the threshold value.

17. The method of claim 15, wherein the temperature sensing device detects an electrical current density at the first spring contact element and/or the second spring contact element and calculates a temperature from the electrical current density.

18. The method of claim 15, wherein the control unit is arranged inside the electrical power connector, the warning signal is a shutdown signal that disconnects the electrical component from the elongated DC power distribution busbar.
